(19) United States
(12) Patent Application Publication
(10) Pub. No.: US 2021/0296062 A1
(43) Pub. Date: Sep. 23, 2021

(54) Keyswitch and Keyboard

(71) Applicants: LITE-ON Technology (Chang Zhou) Co., LTD., Jiangsu Province (CN); LITE-ON Technology Corporation, Taipei City (TW)

(72) Inventors: XiaoQiang LIANG, Jiangsu Province (CN); Wei-Pin CHUANG, Taipei City (TW); Lei SHI, Jiangsu Province (CN); ZhangDong TAN, Jiangsu Province (CN)

(73) Assignees: LITE-ON Technology (Chang Zhou) Co., LTD., Jiangsu Province (CN); LITE-ON Technology Corporation, Taipei City (TW)

(21) Appl. No.: 16/870,434

(22) Filed: May 8, 2020

(30) Foreign Application Priority Data
Mar. 20, 2020 (CN) 202010199353.4

(51) Int. Cl. H01H 13/14; H01H 13/7065; H01H 3/12; H01H 13/83

(52) U.S. Cl. CPC H01H 13/14; H01H 13/7065; H01H 3/12; H01H 2219/062; H01H 2223/003; H01H 2231/044; H01H 13/83

(57) ABSTRACT

The present disclosure provides a keyswitch, comprising an auxiliary component, a membrane circuit, an elastic member, a frame, an elevating component, and a keycap. The membrane circuit is disposed on the auxiliary component. The elastic member is disposed on a surface of the membrane circuit away from the auxiliary component. The frame is disposed on a surface of the membrane circuit away from the auxiliary component. The elastic member is disposed on a surface of the membrane and protrudes from the frame. One end of the elevating component is movably connected to the frame. The elastic member passes through the elevating component. The keycap is movably connected to the other end of the elevating component. The elastic member supports the keycap. The keycap moves upward and downward relative to the frame by the elevating component.

### CROSS REFERENCE TO RELATED APPLICATION

This application claims the priority benefit of Chinese Patent Application Serial Number CN202010199353.4, filed on Mar. 20, 2020, the full disclosure of which is incorporated herein by reference.

### BACKGROUND

### Technical Field

The present disclosure relates to the technical field of input devices, particularly to a keyswitch and a keyboard.

### Related Art

The assembling of the input device of the conventional laptop computer is to sequentially stack metal bottom plate, membrane circuit, elevating component and keycap from the bottom to the top, followed by installing the stacked component to a frame. Since the frame and the metal bottom plate are designed and manufactured individually, it is necessary to individually build a mold for each of them. In this case, there would be tolerances for both the metal bottom plate and the frame during manufacturing process, which usually result in an assemble deviation when assembling the metal bottom plate and the frame, showing the vertical gap between any position of keycap and the frame is inconsistent to offset or skew the keycap when it elevates.

### SUMMARY

The embodiments of the present disclosure provide a keyswitch and a keyboard to solve the problem of the inconsistency of the vertical gap between any position of keycap and the frame in presence of assembling deviation between the metal bottom plate and the frame when engaging the elevating component of the conventional keyswitch to the metal bottom plate under the frame.

In the first aspect, the present disclosure provides a keyswitch, comprising an auxiliary component, a membrane circuit, an elastic member, a frame, an elevating component, and a keycap. The membrane circuit is disposed on the auxiliary component. The elastic member is disposed on the membrane circuit. The frame is disposed on the membrane circuit. One end of the elevating component is movably connected to the frame. The keycap is movably connected with the other end of the elevating component. The keycap moves up and down relative to the frame by the elevating component.

In the second aspect, the present disclosure provides a keyboard comprising the keyswitch having the features of the first aspect above.

In the embodiments of the present disclosure, the elevating component is movably connected to the frame and the keycap, so the vertical gap between any position of keycap and the frame would be consistent to not to offset or skew the keycap when it elevates.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a perspective view of a keyswitch of the first embodiment of the present disclosure;

FIG. 2 is a cross-sectional view of the keyswitch of the first embodiment of the present disclosure;

FIG. 3 is an enlarged view of area A of FIG. 2;

FIG. 4 is an exploded view of the keyswitch of the first embodiment of the present disclosure;

FIG. 5 is an enlarged view of area B of FIG. 4;

FIG. 6 is an enlarged view of area C of FIG. 5;

FIG. 7 is another exploded view of a keyswitch of the first embodiment of the present disclosure;

FIG. 8 is a partially enlarged view of a keyswitch of the second embodiment of the present disclosure;

FIG. 9 is an exploded view of a keyswitch of the third embodiment of the present disclosure;

FIG. 10 is an exploded view of a keyswitch of the fourth embodiment of the present disclosure; and

FIG. 11 is an exploded view of a keyswitch e of the fifth embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals are used to refer to the same or similar elements throughout the disclosure.

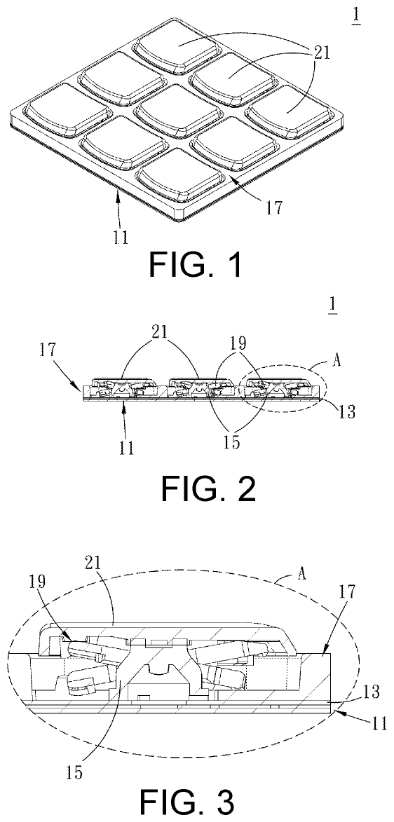

FIG. 1 and FIG. 2 are perspective view and cross-sectional view of a keyswitch of the first embodiment of the present disclosure, and FIG. 3 is an enlarged view of area A of FIG. 2. As shown in the figure, the keyswitch 1 of this embodiment comprises an auxiliary component 11, a membrane circuit 13, an elastic member 15, a frame 17, an elevating component 19, and a keycap 21. The membrane circuit 13 is disposed on the auxiliary component 11. The elastic member 15 is disposed on a surface of the membrane circuit 13 away from the auxiliary component 11. The frame 17 is disposed on a surface of the membrane circuit 13 away from the auxiliary component 11. The elastic member 15 protrudes from the frame 17. One end of the elevating component is movably connected to the frame 17. The elastic member 15 passes through the elevating component 19. The keycap 21 is movably connected to the other end of the elevating component 19. The elastic member 15 supports the keycap 21. The keycap 21 moves upward and downward relative to the frame 17 by the elevating component 19.

In this embodiment, the elevating component 19 is connected to the frame 17 and the keycap 21. Since the vertical gap between any position on the keycap 21 and the frame 17 can be consistent, when the keycap 21 moves upward and downward relative to the frame 17, the keycap 21 does not offset or skew relative to the frame 17.

The keyswitch 1 of this embodiment is a keyswitch in a keyboard. So, the keyboard is provided with a plurality of keyswitches 1 sharing the auxiliary component 11, the membrane circuit 13, and the frame 17. That is, the corresponding plurality of auxiliary components 11 to the plurality of keyswitches 1 is integrally formed to one piece, the corresponding plurality of membrane circuits 13 to the plurality of keyswitches 1 is integrally formed to one piece, and the corresponding plurality of frames 17 to the plurality of keyswitches 1 is integrally formed to one piece.

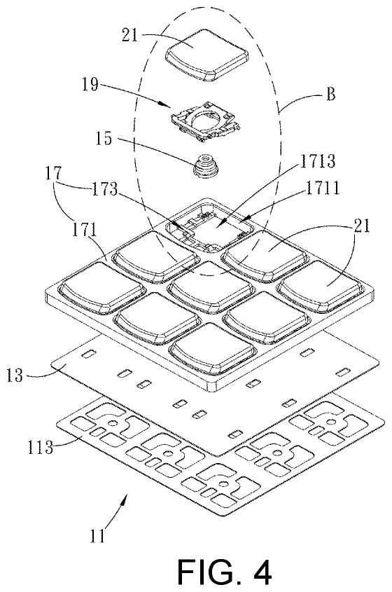

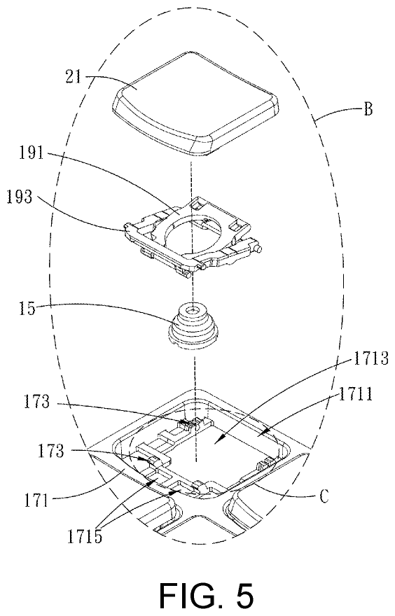

FIG. 4 is an exploded view of the keyswitch of the first embodiment of the present disclosure. FIG. 5 is an enlarged view of area B of FIG. 4. Area B shows the keycap 21, the elevating component 19, the frame 17 and the elastic member 15, and it further explains the elevating component 19 and the frame 17. As shown in the figures, the frame 17 comprises a frame body 171 and a connecting component 173. The frame body 171 comprises an accommodating groove 1711. The connecting component 173 is disposed on the bottom surface of the accommodating groove 1711. One end of the elevating component 19 is movably connected to the connecting component 173. The bottom surface of the accommodating groove 1711 is provided with a perforation 1713. The elastic member 15 protrudes from the perforation 1713. The elevating component 19 of this embodiment works in a scissor mechanism, comprising a first member 191 and a second member 193 rotatably connected to the first member 191. The bottom edge of the first member 191 and the bottom edge of the second member 193 are movably connected to the connecting component 173. The bottom edge of the first member 191 and the bottom edge of the second member 193 are movably connected to the connecting component 173. The above-mentioned elevating component 19 is only an embodiment of the present application, other elevating configurations that move the keycap 21 upward and downward relative to the frame 17 are also acceptable.

Therefore, in the keyswitch 1 of this embodiment, the bottom plate of the conventional keyswitch and connecting component connected with the elevating component are integrated with the frame into one piece. In this embodiment, the connecting component 173 and the frame 17 can be manufactured with the same mold, thereby reducing the overall production cost.

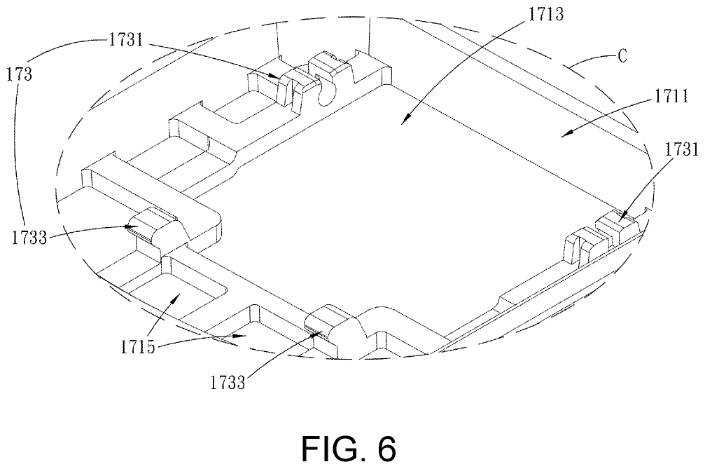

FIG. 6 is an enlarged view of area C of FIG. 5. As shown in the figure, the connecting component 173 of this embodiment comprises a securing part 1731 and a hook part 1733, both are disposed on the bottom surface of the accommodating groove 1711. The connecting component 173 comprising two securing parts 1731 and two hook parts 1733 as an example for description herein. In other embodiments, different numbers of securing parts 1731 and hook parts 1733 can also be used. For example, one securing part 1731 with two hook parts 1733, one securing part 1731 with one hook part 1733, or two securing parts 1731 with one hook part 1733. In this embodiment, the two securing parts 1731 comprise a drop-shaped securing base respectively. The two hook parts 1733 respectively comprise hooks, and a gap exists between one end of the hook having the securing part 1731 and the bottom surface of the accommodating groove 1711. The bottom edge of the second member 193 is movably connected to the securing part 1731 and is directly embedded in the two securing bases. The second member 193 could rotate relative to the securing base. The bottom edge of the first member 191 is movably connected to the hook part 1733, moving into the gap between the hook and the bottom surface of the accommodating groove 1711. The inward movement of the bottom edge of the first member 191 is restricted by the hook. The first member 191 can rotate relative to the hook.

Referring to FIG. 5 and FIG. 6, the bottom surface of the accommodating groove 1711 further comprises a first hollow part 1715 disposed at the periphery of the perforation 1713. The first hollow part corresponds to elevating component 19. Two first hollow parts 1715 are taken as an example for description herein. In other embodiments, it is also possible to take one first hollow 1715 as an example. When the keycap 21 is pressed, the keycap 21 compresses the elevating component 19, so the first hollow part 1715 provides a space for the elevating component 19 to move downward after being compressed.

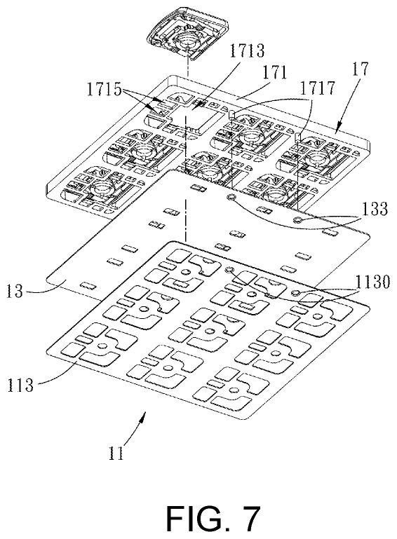

FIG. 7 is another exploded view of a keyswitch of the first embodiment of the present disclosure. In this embodiment, the frame 17 is disposed on a surface of the membrane circuit 13 away from the auxiliary component 11. The auxiliary component 11 comprises a support plate 113 possibly made of plastic or metal. The membrane circuit 13 is disposed on the support plate 113 engaged with the frame 171. The frame 171 comprises a positioning protrusion 1717. The film circuit 13 comprises a positioning hole 133. The positioning protrusion 1717 is disposed in the positioning hole 133. The support plate 113 comprises a securing hole 1130. The positioning protrusion 1717 is disposed in the securing hole 1130. In this way, the frame 17 can easily secure the membrane circuit 13 onto the support plate 113. In one embodiment, after one end of the positioning protrusion, 1717 passes through the supporting plate 113, by hot melting one end of the positioning protrusion 1717, one end of the hot melted positioning protrusion 1717 can be secured to the support plate 113.

In this embodiment, the connecting component 173 connected to the elevating component 19 is integrated with the frame 17. Compared with the prior arts, the keyswitch of the present disclosure would not require a securing component connected to the elevating component 19 disposed on the support plate 113 for supporting the membrane circuit 13, this would help to maintain the surface integrity of the support plate 113, forming an excellent hardness for the support plate 113 of the auxiliary component 11 which enhances the support to the membrane circuit 13. Meanwhile, by integrating connecting component 173 connected to the membrane circuit 13 and the elevating component 19, the holes on the securing component connected to the elevating component 19 cooperating with the support plate 113 of the membrane circuit 13 can also be reduced. This would also help to maintain the surface integrity of the membrane circuit 13. Thus, the waterproofness and wiring safety of the keyswitch 1 can be increased.

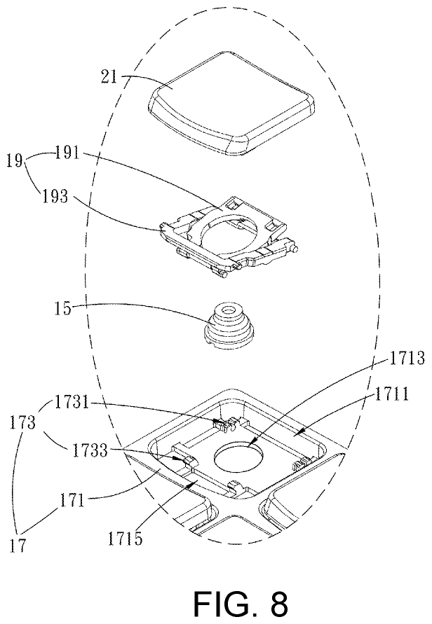

FIG. 8 is a partially enlarged view of a keyswitch of the second embodiment of the present disclosure. As shown in the figure, the difference between the keyswitch of this embodiment and that of the first embodiment is the shape and distribution of the perforation 1713 and the first hollow part 1715 on the bottom surface of the accommodating groove 1711. In this embodiment, the perforation 1713 is circular, and the elastic member 15 is disposed in the perforation 1713. The first hollow part 1715 is adjacent to the two hook parts 1733 and extends from one hook part 1733 to the other hook part 1733.

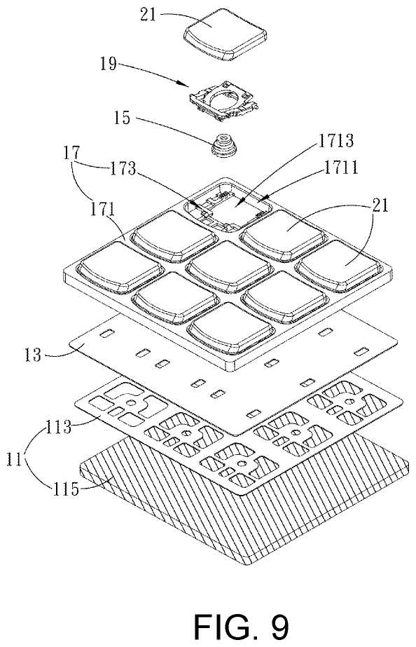

FIG. 9 is an exploded view of a keyswitch of the third embodiment of the present disclosure. As shown in the figure, the difference between the keyswitch of this embodiment and that of the first embodiment lies in the auxiliary component 11. In this embodiment, the auxiliary component 11 comprises a support plate 113 and a waterproof layer 115 disposed on the surface of the support plate 113 away from the membrane circuit 13. The support plate 113 supports the membrane circuit 13. The waterproof layer 115 provides waterproof function to keep external moisture from entering the support circuit 113 to the membrane circuit 13 to prevent the membrane circuit 13 from being damaged by moisture.

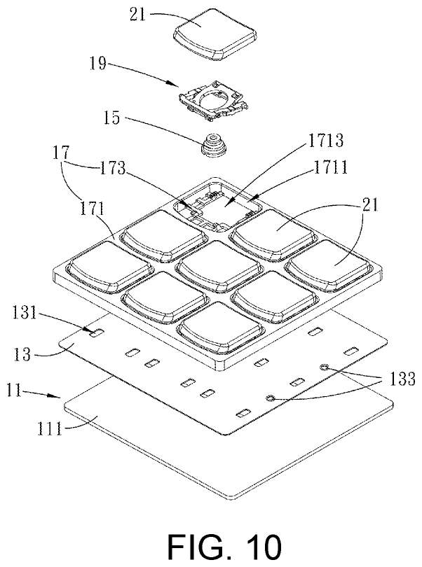

FIG. 10 is an exploded view of a keyswitch of the fourth embodiment of the present disclosure. As shown in the figure, the difference between the keyswitch of this embodiment and that of the first embodiment lies in the auxiliary component 11. In this embodiment, the auxiliary component 11 comprises a backlight module 111 disposed on the surface of the membrane circuit 13 away from the frame 17. The membrane circuit 13 comprises a second hollow part 131 corresponding to the first hollow part 1715. The backlight module 111 supports the membrane circuit 13. The backlight module 111 can project light to the keycap 21 through the second hollow part 131 and the first hollow part 1715, and the light would be emitted from the periphery of the keycap 21.

In addition, the backlight module 111 further comprises a securing hole (not shown). The positioning protrusion of the frame 17 can pass through the positioning hole 133 of the membrane circuit 13 and then further secured to the securing holes of the backlight module 111. In this way, the frame 17 and the backlight module 111 can be firmly engaged.

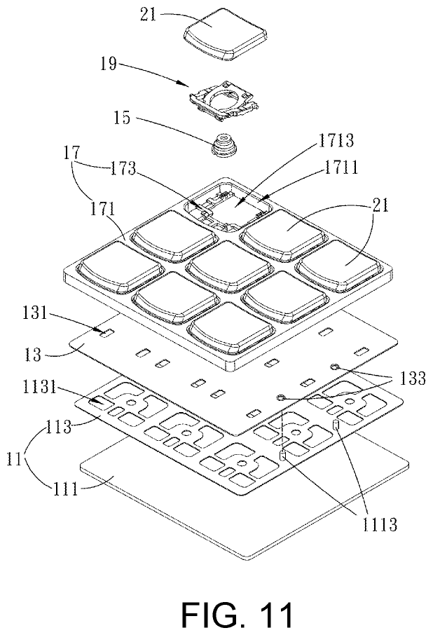

FIG. 11 is an exploded view of a keyswitch e of the fifth embodiment of the present disclosure. As shown in the figure, the difference between the keyswitch of this embodiment and that of the fourth embodiment lies in the auxiliary component 11. In this embodiment, the auxiliary component 11 further comprises a support plate 113 disposed between the membrane circuit 13 and the backlight module 111. The support plate 113 comprises a third hollow part 1131 corresponding to the second hollow part 131 and the first hollow part. The support plate 113 can increase the rigidity of the membrane circuit 13 and support the membrane circuit 13. In addition, the light emitted from the backlight module 111 passes through the third hollow part 1131 and enters the second hollow part 131 and the first hollow part, so that the light emitted from the backlight module 111 would be projecting toward the keycap 21.

In summary, the present disclosure proposed a keyswitch and a keyboard. The elevating component is movably connected to the frame and the keycap, so the vertical gap between any position of the keycap and the frame would be consistent to not to offset or skew the keycap when it elevates. In addition, the area of the holes on the support plate in the auxiliary component is greatly reduced, thereby the support plate can be having excellent integrity and hardness to effectively improve the supporting of the support plate to the membrane circuit. The waterproofness and wiring safety of the entire keyswitch would be also greatly improved as the area of the holes on the membrane circuit is greatly reduced.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

1. A keyswitch, comprising:
an auxiliary component;
a membrane circuit disposed on the auxiliary component;
an elastic member disposed on the membrane circuit;
a frame disposed on the membrane circuit;
an elevating component, one end of which is movably connected to the frame; and
a keycap movably connected with the other end of the elevating component, the keycap moving upward and downward relative to the frame by the elevating component;
wherein the auxiliary component comprises a backlight module disposed on a surface of the membrane circuit away from the frame to support the membrane circuit.

2. The keyswitch according to claim 1, wherein the auxiliary component comprises a support plate engaged with the frame.

3. The keyswitch according to claim 2, wherein the auxiliary component comprises a waterproof layer disposed on a surface of the support plate away from the membrane circuit.

4. The keyswitch according to claim 1, wherein the backlight module is engaged with the frame.

5. The keyswitch according to claim 4, wherein the auxiliary component comprises a support plate; the backlight module is disposed on a surface of the support plate away from the membrane circuit.

6. The keyswitch according to claim 1, wherein the frame comprises a frame body and a connecting component connected to the frame body; one end of the elevating component is connected to the connecting component, the connecting component comprising a perforation and a first hollow part; the elastic member passes through the perforation; the first hollow part is disposed at the periphery of the perforation; the first hollow part corresponds to the elevating component.

7. The keyswitch according to claim 6, wherein the elevating component comprises a first member and a second member rotatably connected to the first member; the bottom edge of the first member and the bottom edge of the second member are movably connected to the connecting component.

8. The keyswitch according to claim 6, wherein the membrane circuit comprises a second hollow part corresponding to the first hollow part or the perforation.

9. The keyswitch according to claim 6, wherein the auxiliary component comprises a third hollow part corresponding to the first hollow part or the perforation.

10. The keyswitch according to claim 1, wherein the frame comprises a positioning protrusion; the membrane circuit comprises a positioning hole; the positioning protrusion is disposed in the positioning hole.

11. A keyboard comprising a keyswitch, comprising:
an auxiliary component;
a membrane circuit disposed on the auxiliary component;
an elastic member disposed on the membrane circuit;
a frame disposed on the membrane circuit;
an elevating component, one end of which is movably connected to the frame; and
a keycap movably connected with the other end of the elevating component, the keycap moving upward and downward relative to the frame by the elevating component;
wherein the auxiliary component comprises a backlight module disposed on a surface of the membrane circuit away from the frame to support the membrane circuit.

12. The keyswitch according to claim 11, wherein the auxiliary component comprises a support plate engaged with the frame.

13. The keyswitch according to claim 12, wherein the auxiliary component comprises a waterproof layer disposed on a surface of the support plate away from the membrane circuit.

14. The keyswitch according to claim 11, wherein the backlight module is engaged with the frame.

15. The keyswitch according to claim 14, wherein the auxiliary component comprises a support plate; the backlight module is disposed on a surface of the support plate away from the membrane circuit.

16. The keyswitch according to claim 11, wherein the frame comprises a frame body and a connecting component connected to the frame body; one end of the elevating component is connected to the connecting component, the connecting component comprising a perforation and a first hollow part; the elastic member passes through the perforation; the first hollow part is disposed at the periphery of the perforation; the first hollow part corresponds to the elevating component.

17. The keyswitch according to claim 16, wherein the elevating component comprises a first member and a second member rotatably connected to the first member; the bottom edge of the first member and the bottom edge of the second member are movably connected to the connecting component.

18. The keyswitch according to claim 16, wherein the membrane circuit comprises a second hollow part corresponding to the first hollow part or the perforation.

19. The keyswitch according to claim 6, wherein the auxiliary component comprises a third hollow part corresponding to the first hollow part or the perforation.

20. The keyswitch according to claim 11, wherein the frame comprises a positioning protrusion; the membrane circuit comprising a positioning hole; the positioning protrusion is disposed in the positioning hole.
